(19) United States
(12) Patent Application Publication
(10) Pub. No.: US 2014/0305977 A1
(43) Pub. Date: Oct. 16, 2014

(54) Cargo Box and Table Extension for a Truck Bed

(71) Applicant: Gary M. Sparks, Brunswick, GA (US)

(72) Inventor: Gary M. Sparks, Brunswick, GA (US)

(21) Appl. No.: 14/252,040

(22) Filed: Apr. 14, 2014

Related U.S. Application Data
(60) Provisional application No. 61/812,332, filed on Apr. 16, 2013.

(51) Int. Cl. B60P 1/64; B60R 9/06

(52) U.S. Cl. CPC B60P 1/6427; B60R 9/065
USPC 224/404

(57) ABSTRACT

A movable cargo box case sized to fit between the wheel wells of a pickup truck contains a cargo box mounted on rollers within the case. The case is positioned in front of the truck tailgate so that the tailgate operates normally. When the truck is stopped and the tailgate opened, the cargo box can be pulled out of the case without interfering with any load on top of the case. The rear end of the box comprises foldable legs that are extended to contact the ground behind the truck to support the rear end of the box.

### CROSS-REFERENCE TO RELATED APPLICATIONS

This is a non-provisional of U.S. provisional patent application Ser. No. 61/812,332, filed Apr. 16, 2013.

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

The instant invention is in the field of devices built to make use of certain parts of the bodies of land vehicles, more particularly in the field of devices built for transport in the beds of trucks. Still more particularly, this invention is in the field of devices used in the beds of pickup trucks, and even more particularly devices for containment of tools and parts.

There are numerous devices that have been made for carriage and use in the beds of pickup trucks, as diverse as hoists, winches, compressors, dog kennels, deer stands, glass racks, tanks, fifth wheels, tool boxes, and many more. Cargo boxes in the beds of pickups (as opposed to ones built into the outer body) consist generally of tool boxes that are either free-standing or are in the form of truck boxes that extend the width of the bed and are mounted directly behind the cab. There is a need for a cargo box that can be placed in a typical pickup truck bed and secured for travel behind the tailgate, and once the tailgate is opened can be extended rearwardly and self-supportably for the dual purpose of bringing tools or parts out of the truck for easier access and providing a flat horizontal surface for holding large objects or to serve as a table. One product available at the time of the filing of this application that has the rearward extension capability of the instant invention is the Roller Coaster™ truck bed extender by Highway Products, Inc. of 7905 Agate Road, White City, Oreg. 97503. It uses a pair of tracks that must be bolted to the bottom of the bed and provides no ground support for the extended end.

### SUMMARY OF THE INVENTION

The instant invention is a movable cargo box case sized to fit between the wheel wells of a pickup truck. The cargo box is mounted on rollers within the case. Because most modern pickups have wheel wells within the bed area, the height of the case of the instant invention is constructed to equal to the typical height of wheel wells so that the top of the case effectively increases the useful width of the bed. The case is reinforced vertically to handle whatever load would be placed in the truck bed. During travel, the cargo box is fully contained within the case, and the rear end of the box acts as a door to close the case. The case is positioned in front of the truck tailgate so that the tailgate operates normally. When the truck is stopped and the tailgate opened, the cargo box can be pulled out of the case without interfering with any load on top of the case. The rear end of the box comprises foldable legs that are extended to contact the ground behind the truck to support the rear end of the box.

The preferred embodiment has a plurality of compartments built into the box, each with its own lid. The lids are fitted so as to provide a flat, horizontal surface on top of the box. In other embodiments, there may be one compartment with or without a lid or a plurality of compartments with some or no lids.

### BRIEF DESCRIPTION OF THE DRAWINGS

FIG. 1 is a partially-exploded perspective view of the instant invention.

FIG. 2 is a perspective view of the instant invention installed in the bed of a pickup truck.

### DETAILED DESCRIPTION OF THE INVENTION

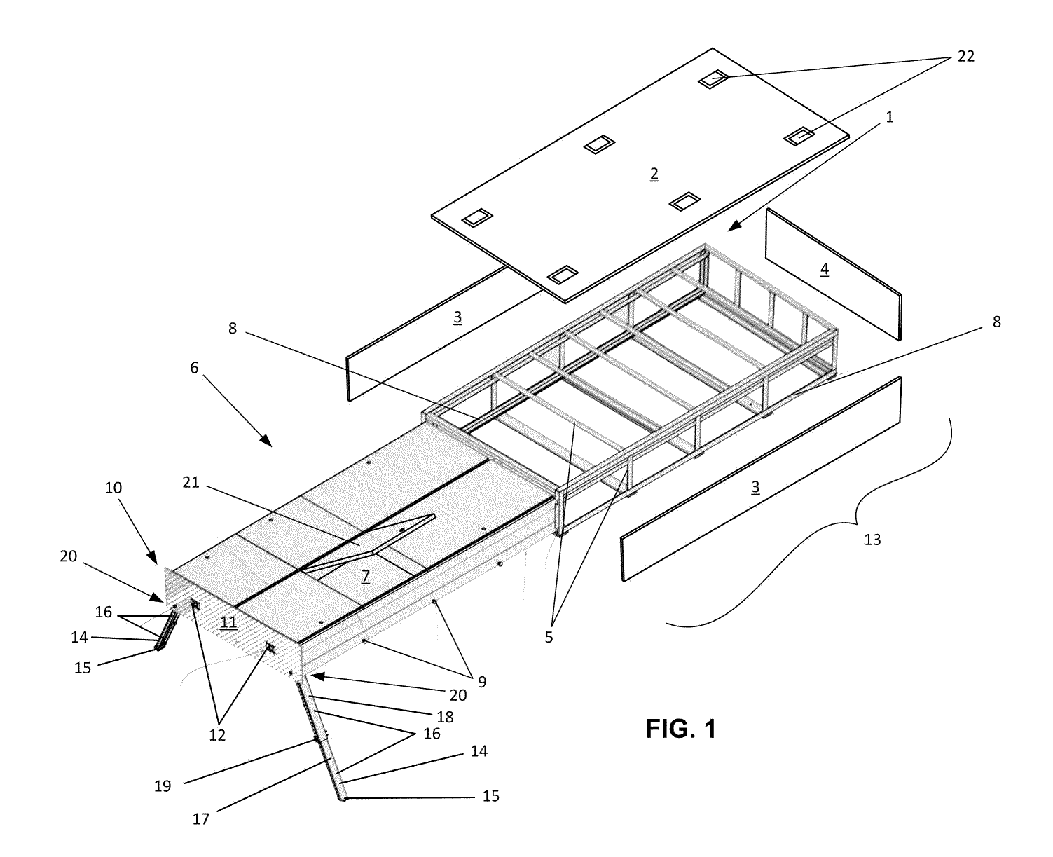

Referring now to the invention in more detail, in which like reference numerals refer to like features in each of the several drawings, FIG. 1 is a partially-exploded perspective view of the instant invention. It comprises a case frame 1 which is completed into a case 13 with a top panel 2, two side panels 3 and a front panel 4 welded to corresponding locations on the frame 1 as shown. The front panel is so-called here because it faces the front of the truck. The panels are shown in exploded view to reveal the numerous horizontal and vertical stiffeners 5 which enable the assembled case to support a significant load on the top panel 2. The top panel 2 optionally may comprise one or more handles 22 to enable the invention to be lifted in its entirety and moved to another location or another truck. The frame 1 alternatively may be fastened permanently to the bed of a truck.

A drawer 6 comprising one or more compartments 7, which may have lids, one of which 21 is shown open, is sized to roll into and out of the frame 1. This view also shows the left and right cam tracks 8 which not only provide longitudinal strength to the frame 1 but also provide an unimpeded path for the drawer cams 9 to roll on.

The rear end 10 of the drawer 6 has an end panel 11 with locking latches 12, so that when the rear end 10 is pushed into the case 13, the drawer 6 can be secured shut. The rear end 10 also comprises a plurality of legs 14 with ground-contacting ends 15. The ground-contacting ends 15 may comprise skids or wheels (not shown) to enable the drawer 6 to be moved in or out of the case 13 over the ground. The legs have a plurality of segments, two segments 16 for example for each leg 14 as shown in this figure. The length of a leg 14 can be adjusted by telescoping a lower segment 17 into an upper segment 18 and fixing the resulting length with a length locking means 19, shown here as a pin 19 through holes in both segments. To prepare the drawer 6 for rolling back into the case 13, the locking means 19 are released and the segments 16 are telescoped upward as far as they will go. The upper ends 20 of the legs 14 are equipped with pivoting means that allow the legs 14 to be folded upward and inward for stowage under the drawer 6 either parallel to the end panel 11, or upward and forward parallel to the side panels 3. Alternatively, the legs 14 may be raised outwardly to a horizontal position and slid towards each other on tracks parallel to, and just inside, the end panel 11.

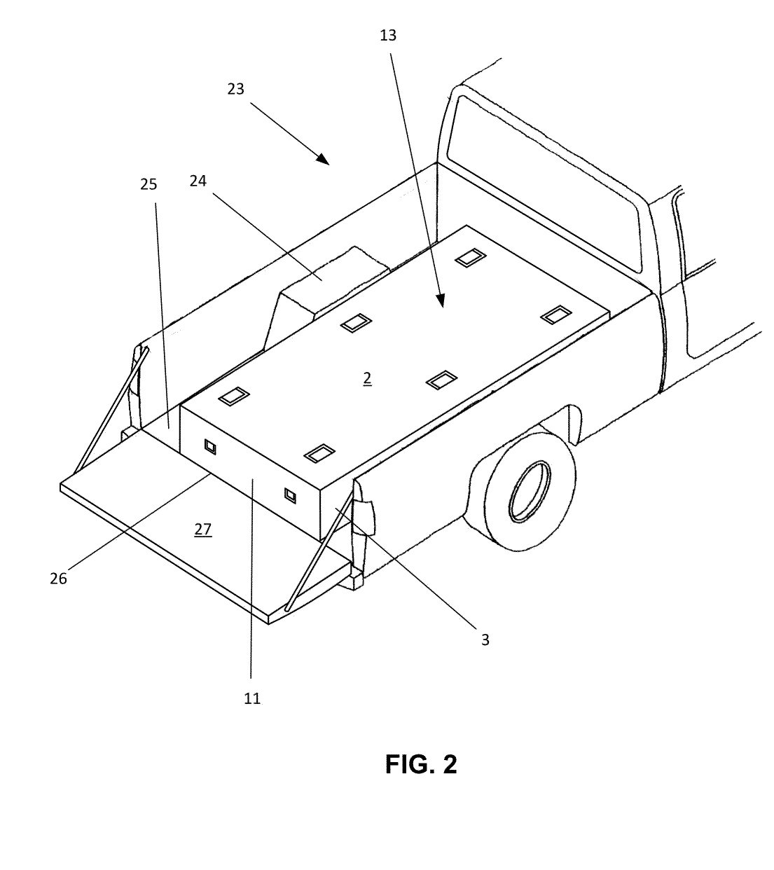

FIG. 2 is a perspective view of the instant invention installed in the bed of a pickup truck. This truck 23 has wheel wells 24 (only one of which is shown here) the separation of which, while not standard, is similar among full-sized pickups. The case 13 of the instant invention is sized to fit such trucks, but may built to any size (length or width) to fit a particular truck bed.

Note that the case 13 has been placed into the truck bed 25 so that the end panel 11 is just forward of the hinge 26 of the tailgate 27. The tailgate can be closed to retain the case 13, or, alternatively, the case 13 may be affixed to the bed 25 by bolting or welding or the like.

In an embodiment, weatherproofing may be placed at the joints between the end panel 11 and the top panel 2 and side panels 3 to protect the contents of the invention from the weather in case the truck 23 has an open bed. In the same embodiment, it is preferable that the edges adjoining the top panel 2 to the side panels 3 and the front panel 4 (hidden from view) are completely weatherproof either by full-length welding or waterproofing compound.

1. A table extension apparatus for a truck bed, comprising:
a case having a top panel, left and right side panels, and an open end facing the rear of the truck bed;
the case being attachable to a truck bed;
a drawer moveable into and out of the open end the case;
the drawer comprising
a top, a bottom, a rear end panel;
a plurality of legs;
the legs projecting downwardly to contact the ground when the drawer is slid out of the open end of the case; and
means for the legs to be collapsed against the bottom of the drawer before the drawer is slid into the open end of the case.

2. The apparatus of claim 1, in which:
said plurality of legs is a right leg and a left leg; and
said means for the legs to be collapsed against the drawer comprises hinges at the top of the legs permitting the legs to rotate upwardly with respect to the drawer in a direction taken from the list of:
(a) forwardly, so that the right leg folds into a position underneath said bottom and parallel to said right panel and the left leg folds into a position underneath the bottom and parallel to said left panel; and
(b) in a plane parallel to said rear end panel, the means further allowing each leg to be shortened to a length no greater than the width of said rear end panel so that the legs fold into a position underneath said bottom and parallel to said rear end panel.

3. The apparatus of claim 2, in which:
said legs have bottom ends comprising means for reducing friction against the ground.

4. The apparatus of claim 3, in which:
said means for reducing friction against the ground is taken from the list of:
(a) a wheel;
(b) a roller;
(c) a caster
(d) a skid; and
(e) combinations of the above.

5. The apparatus of claim 2, in which:
said drawer comprises at least one compartment; and
said drawer top comprises at least one lid for the at least one compartment.

6. A table extension apparatus for a pickup truck having a bed, right and left wheel wells within the bed separated by a width, a wheel well height, and a tailgate, comprising:
a case having a top panel, left and right side panels, an open end facing the rear of the truck bed, a height above the truck bed substantially equal to the wheel well height, and a width parallel to rear of the truck bed substantially equal to the width separating the wheel wells so that the top panel and the top of the wheel wells form a table;
the case being attachable to the truck bed;
a drawer slidable into and out of the open end the case;
the drawer comprising
a top, a bottom, a rear end panel;
the rear end panel being positioned forwardly of the tailgate so that the tailgate can close behind it;
right and left legs;
the legs projecting downwardly to contact the ground when the drawer is slid out of the open end of the case; and
hinges at the top of the legs permitting the legs to rotate upwardly with respect to the drawer in a direction taken from the list of:
(a) forwardly, so that the right leg folds into a position underneath said bottom and parallel to said right panel and the left leg folds into a position underneath the bottom and parallel to said left panel; and
(b) in a plane parallel to said rear end panel, the means further allowing each leg to be shortened to a length no greater than the width of said rear end panel so that the legs fold into a position underneath said bottom and parallel to said rear end panel;
at least one compartment; and
the drawer top comprising at least one lid for the at least one compartment.

7. The apparatus of claim 6, in which:
said legs have bottom ends comprising means for reducing friction against the ground.

8. The apparatus of claim 7, in which:
said means for reducing friction against the ground is taken from the list of:
(a) a wheel;
(b) a roller;
(c) a caster
(d) a skid; and
(e) combinations of the above.

9. A cargo box and table extension for a truck bed, comprising:
a case attachable to the truck bed having a flat top and an opening facing the rear;
the case having a frame capable of holding on its top the load capacity of the truck;
a cargo box drawer sized to fit within the case and extendable into and out of the case on rollers;
the drawer having a plurality of cargo compartments with upward-facing lids;
the lids forming a flat table;
the drawer having a top, a bottom, and a rear end panel;
the rear end panel being positioned forwardly of the tailgate so that the tailgate can close behind it;
the drawer having right and left legs that are hinged to the drawer proximate to the rear end panel;
the legs being extendable downward and of a length allowing them to reach the ground;
the legs being foldable at the hinges to stow underneath the drawer before it is rolled into the case.

10. The apparatus of claim 9, in which:
said legs are adjustable in length.

11. The apparatus of claim 10, in which:
said legs have bottom ends comprising means for reducing friction against the ground.

12. The apparatus of claim 11, in which:
said means for reducing friction against the ground is taken from the list of:
(a) a wheel;
(b) a roller;
(c) a caster
(d) a skid; and
(e) combinations of the above.
